(19) United States
(12) Patent Application Publication
(10) Pub. No.: US 2009/0222455 A1
(43) Pub. Date: Sep. 3, 2009

(54) COMMUNICATION PROCESS AND DEVICE

(75) Inventors: Alain Molinie, Montpellier (FR); Eric Lavigne, Montpellier (FR); Vincent Leclaire, Montpellier (FR); Alexis Martial, Montpellier (FR)

Correspondence Address: YOUNG & THOMPSON, 209 Madison Street, Suite 500, ALEXANDRIA, VA, 22314, US

(73) Assignee: AWOX, CLAPIERS (FR)

(21) Appl. No.: 12/161,959

(22) PCT Filed: Dec. 6, 2007
(86) PCT No.: PCT/FR07/02010

§ 371 Date: Nov. 21, 2008

(30) Foreign Application Priority Data
Dec. 6, 2006 (FR) 06/10700

(51) Int. Cl. G06F 17/30

(52) U.S. Cl. 707/10; 707/E17.01

(57) ABSTRACT

The device for communications between at least one multimedia content medium accessible by a network and a host system able to process the content, includes, in a case:
a connector adapted to be connected to the host system;
a unit for managing the connector utilizing a protocol authorizing connections and disconnections of data carriers to the host system, said host system being able to read files present in said case;
a unit for communicating with the network utilizing an interface management protocol;
a unit of simulation adapted, in order to represent the contents accessible to the host system via the communications unit and the network, to simulate, on the host system, a tree-structure of files present in the case and
a way of accessing at least one content accessible by the network through use of its representation in the tree-structure.

The present invention concerns a communication process and a communication device. It applies, in particular, to multimedia types of wireless local data communications.

In the market of mass-market audio-video devices, such as televisions, compact disk readers and Hi-Fi systems, a large number of these devices are equipped with a USB port able to read the content of a mass storage device. In this way, these machines allow the MP3, JPEG, etc files stored on a USB key or a hard disk with a USB interface to be directly used.

At the same time, the increasing power of domestic networks and WiFi interfaces leads to a need to share data that may come from a variety of sources and be used in various places.

The present invention aims to spare users from having to purchase new hardware to meet these new needs.

To this end, the present invention envisages, according to a first aspect, a device for communications between at least one multimedia content medium accessible by means of a network and a host system able to process a said content, that comprises, in a case:
a connector adapted to be connected to the host system;
a means of managing the connector utilizing a protocol authorizing connections and disconnections of data carriers to the host system, said host system being able to read files present in said case;
a means of communication with said network utilizing an interface management protocol;
a means of simulation adapted, in order to represent said contents accessible to the host system by means of the communications means and the network, to simulate, on the host system, a tree-structure of files present in said case and
a means of access to at least one said content accessible by means of the network through use of its representation in said tree-structure.

Thanks to these provisions, by connecting said case to a host file-reading system, this latter can access remote data as if it was located locally in said case.

In this way, the media present on remote systems, for example video or audio, can be read and output by the host system, thus called a “media renderer”, for example a television, or a Hi-Fi system or a computer. Devices equipped with a port compatible with the connector can thus access the data of a domestic or office network, even the Internet, by making the device think that it is dealing with a standard data storage key.

According to particular features, the means of simulation is adapted in that the root of the simulated tree-structure is the network.

According to particular features, the host system is a media renderer.

According to particular features, said network is connected to the Internet.

According to particular features, the device that is the subject of the present invention, as briefly described above, comprises a means of receiving unrequested content coming from said network.

According to particular features, said connector is a USB type (acronym for “Universal Serial Bus”).

According to particular features, said connector is an SD/MMC type (acronym for “Secure Digital/MultiMedia Card”).

According to particular features, said connector is an IEEE1394 type.

According to particular features, said connector is a wireless connector, of Wireless USB type (acronym for “Wireless Universal Serial Bus”).

According to particular features, the means of communication is a means of communication utilizing the UPnP standard (acronym for “Universal Plug and Play”).

According to particular features, the interface management protocol used utilizes the UPnP standard (acronym for “Universal Plug and Play”, a standard for communication over the local network).

According to particular features, the interface management protocol used utilizes the MMS standard (acronym for “Microsoft Media Services”, a standard for multimedia file communication over the network).

According to particular features, the interface management protocol used utilizes the RTSP standard (acronym for “Real Time Streaming Protocol”, a standard for multimedia file communication over the network).

According to particular features, the means of communication is a wireless means of communication utilizing the WiFi standard (acronym for “Wireless Fidelity”).

According to particular features, the means of simulating the tree-structure is adapted to represent, by a directory, the contents accessible by means of the network over the same remote device.

According to particular features, the device that is the subject of the present invention, as briefly described above, comprises a means of emulating a file system of FAT type (acronym for “File Allocation Table”) by re-directing requests to access files coming from the host system to the network servers, via said protocol.

According to particular features, the device that is the subject of the present invention, as briefly described above, comprises a means of simulating, for the host system, the disconnection and re-connection of the device, on the one hand, and of the host system, on the other hand, during a pre-defined event assigning a remote connection with an available data server.

According to particular features, the device that is the subject of the present invention, as briefly described above, comprises a means of inhibiting the means of simulating the disconnection and re-connection during a transfer of available remote data to the host system.

According to particular features, the means of simulating the local file tree-structure adapted to represent remote data is adapted to only determine a directory's sub-directories during an access to the directory by the host system.

According to particular features, the device that is the subject of the present invention, as briefly described above, comprises a means of transcoding data available remotely received from the host system.

Thus, the device transcodes “on the fly” from any format whatsoever to one or more format(s) defined by the user according to the host system's capabilities. Thus the device that is the subject of the present invention can take any format whatsoever out of the network and, in real-time, transform it into an intermediary format, or “pivot”, requiring the addition of a transcoding layer between the UPnP (which is only responsible for transport and availability) and the virtual file system by which the host system receives the data.

According to particular features, the device that is the subject of the present invention, as briefly described above, comprises a means of configuring by the user the simulation of the tree-structure, a transcoding, an identification of the user and/or the communication with said network.

The present invention envisages, according to a second aspect, a process of communication between at least one multimedia content medium accessible by means of a network and a host system able to process a said content, characterized in that it comprises:
a step of managing a connector of a case adapted to be connected to the host system, utilizing a protocol authorizing connections and disconnections of data carriers to the host system, said host system being able to read files present in said case;
a step of communicating with said network utilizing an interface management protocol;
a simulation step, in order to represent said contents accessible to the host system by means of the communications means and the network, by simulating, on the host system, a tree-structure of files present in said case and
a step of accessing at least one said content accessible by means of the network through use of its representation in said tree-structure.

As the particular characteristics, advantages and aims of this process are similar to those of the device that is the subject of the present invention, as briefly described above, they are not repeated here.

Other advantages, aims and characteristics of the present invention will become apparent from the description that will follow, made, as an example that is in no way limiting, with reference to the accompanying drawings, in which:

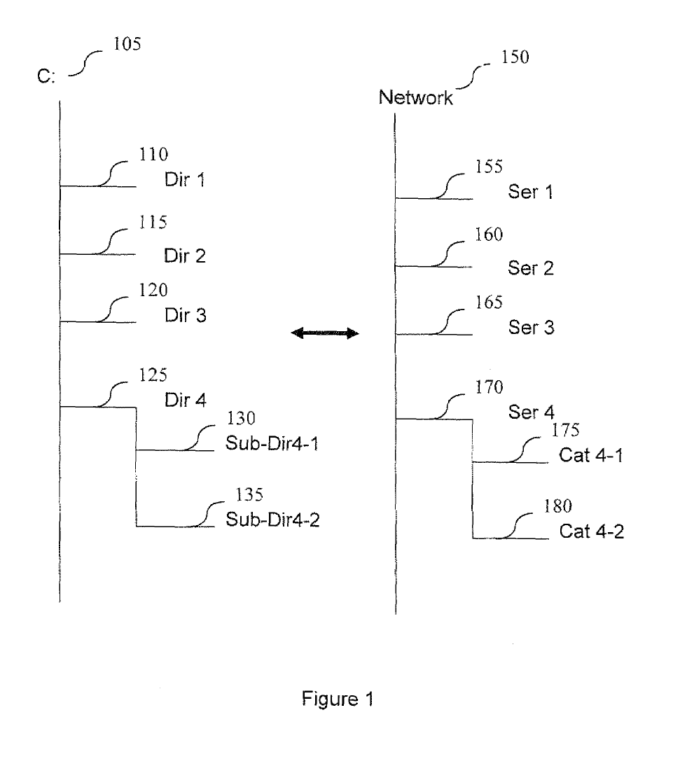

FIG. 1 represents, schematically, file systems,

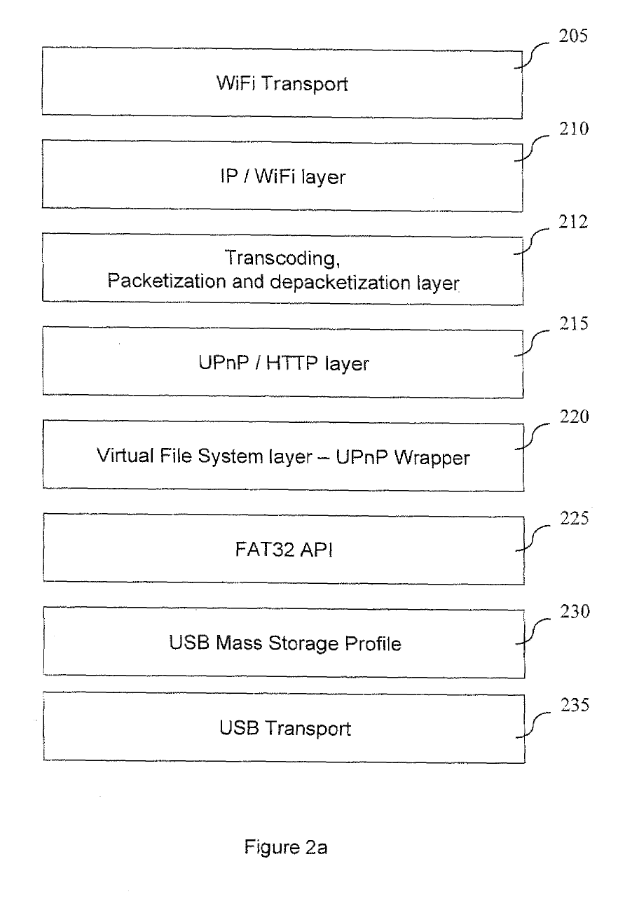

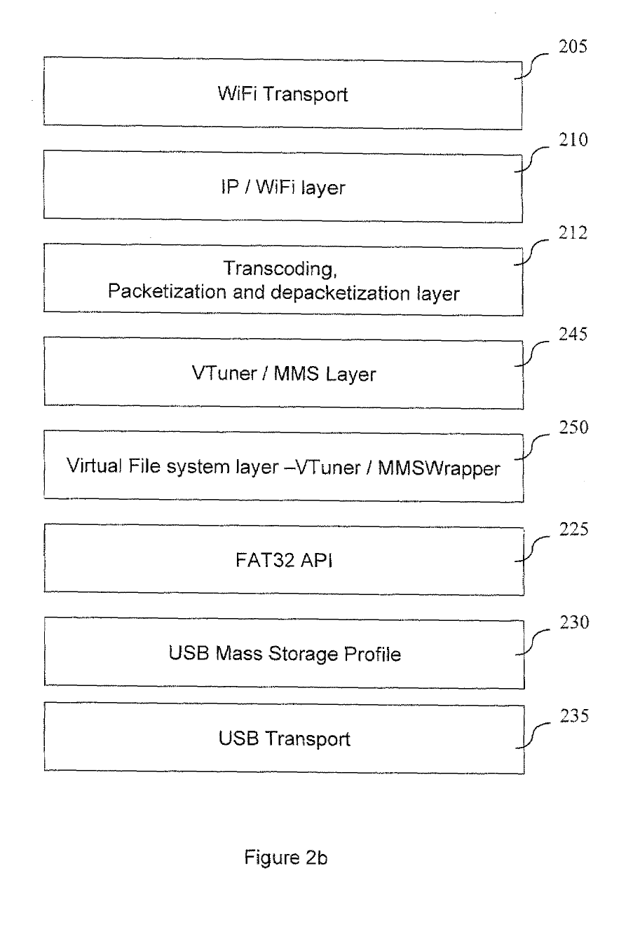

FIGS. 2a-2c represent, schematically, in the form of layers of the ISO standard, the software elements utilized in a first particular embodiment of the device that is the subject of the present invention,

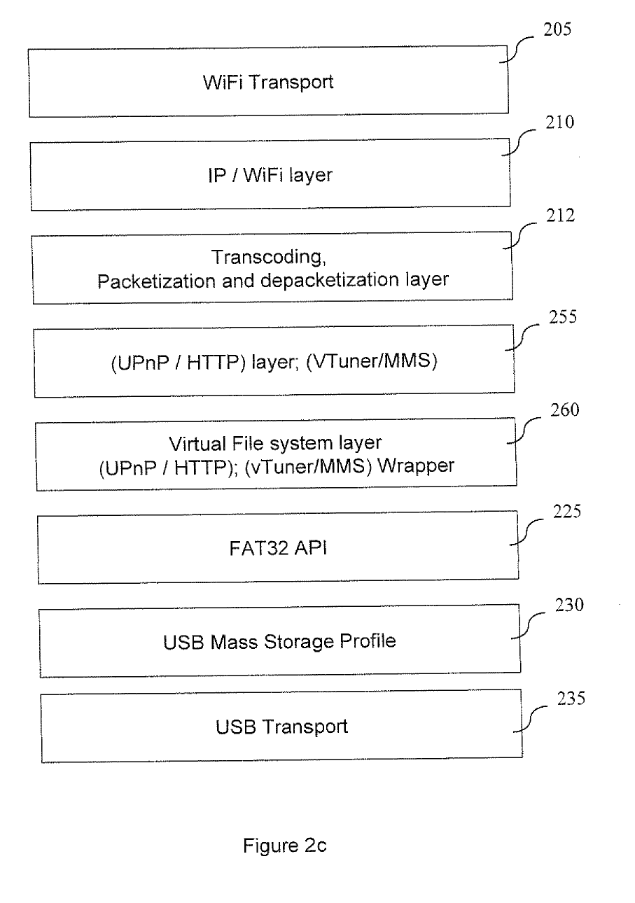

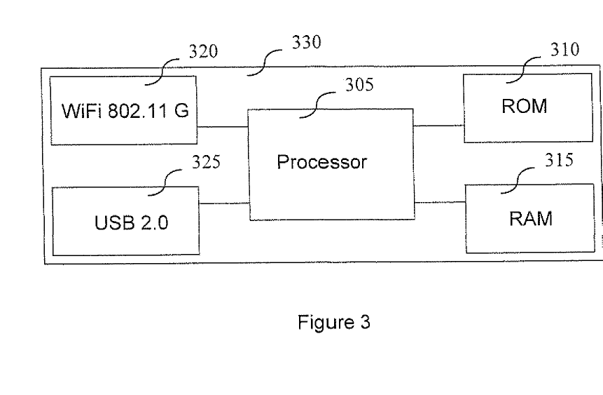

FIG. 3 represents, schematically, in the form of a block diagram, the components of a particular embodiment of the device that is the subject of the present invention,

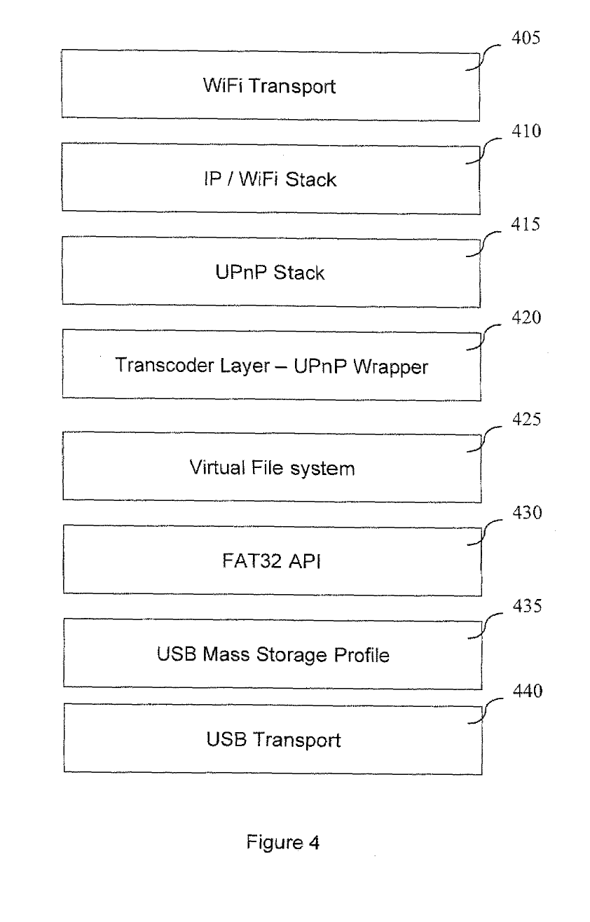

FIG. 4 represents, schematically, in the form of layers of the ISO standard, the software elements utilized in a second particular embodiment of the device that is the subject of the present invention,

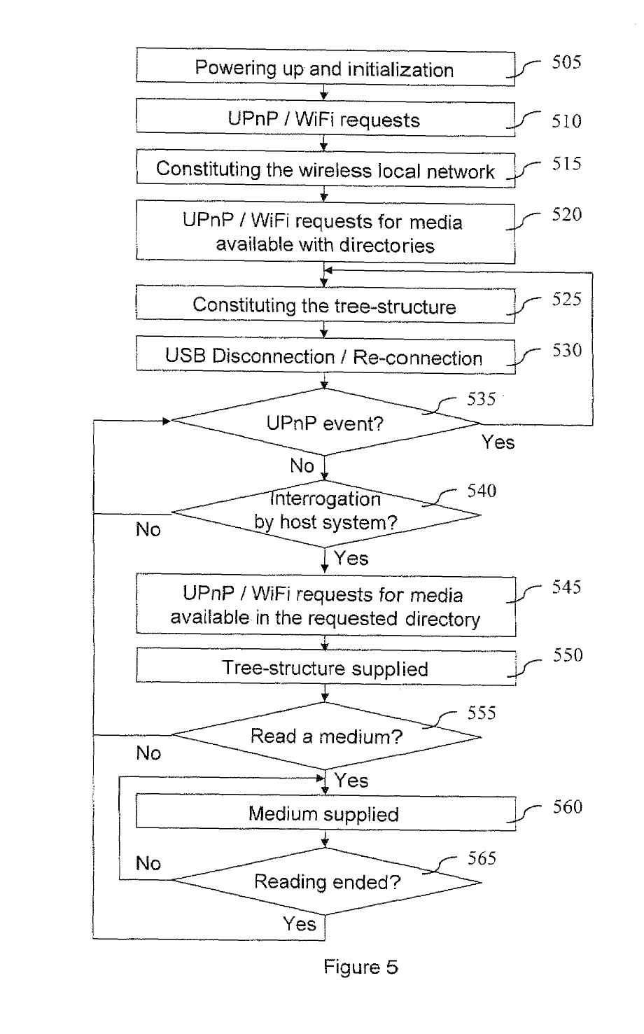

FIG. 5 represents, in the form of a logical diagram, steps utilized in a particular embodiment of the process that is the subject of the present invention,

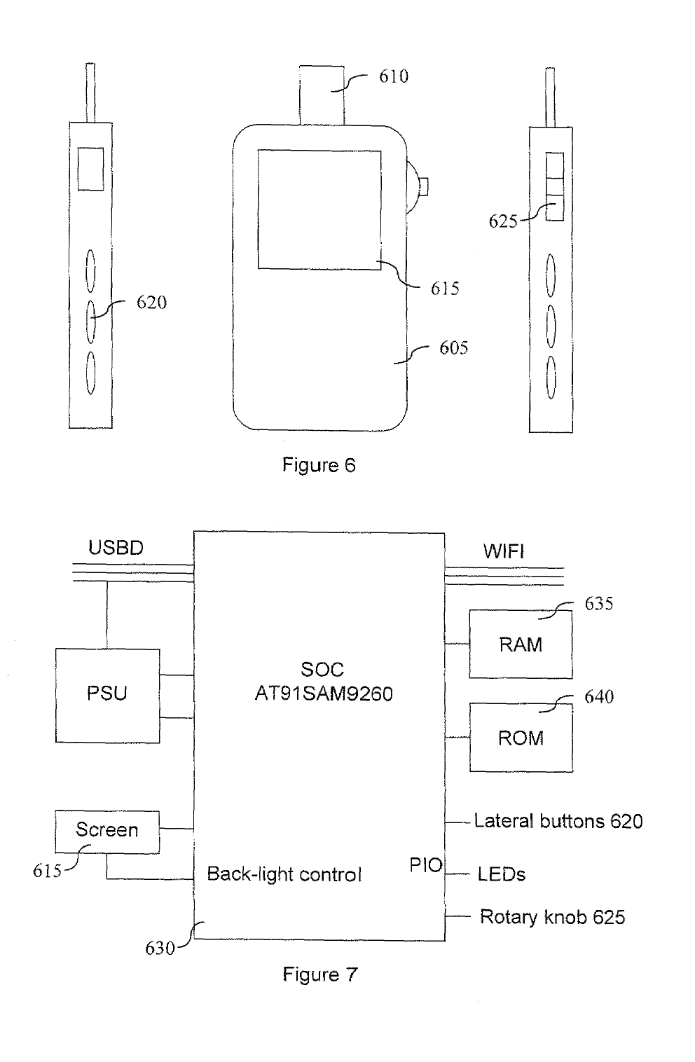

FIG. 6 represents a possible physical and mechanical implementation of the process that is the subject of the present invention and

FIG. 7 represents components of a printed circuit integrated to the physical implementations shown in FIG. 6.

Throughout the description, the following acronyms are used:
“AV”=Audio Video,
“MP3”=MPEG 1 Layer 3=audio digital compression standard,
“WMA”, Windows Media Audio, audio digital compression standard,
“WMV”, Windows Media Video, video digital compression standard,
“MMS”, Microsoft Media Services, a standard for multimedia file communication over the Internet,
“RTSP”, Real Time Streaming Protocol, a standard for multimedia file communication over the Internet,
“MPEG” Moving Pictures Experts Group, standard for the compression of animated images (preferentially, in this case this concerns versions 2 and 4),
“JPEG”=digital image compression standard,
“USB”=Universal Serial Bus,
“UPnP”=Universal Plug and Play,
“WiFi”=Wireless Fidelity,
“FAT”=File Allocation Table,
“API”=Application Programming Interface.

It is noted that a mass storage medium, such as a USB key, is only a means of storing bytes without structuring. The way of sequencing these bytes, filing them under logical structures (files, directories), providing mechanisms for protecting data and correcting errors are the jurisdiction of a software module called a “file system”, of which there are many variants. These different file systems are adapted to specific needs, such as speed, fragmentation, control methods, the rotation of the areas used on the physical medium, etc. However, the actual standard in “classic” use that does not require special characteristics is known as FAT32, and is recognized by almost all of the host systems. This standard is therefore, to some extent, “universal”.

A “modern” operating system provides an abstraction layer allowing any file system implementation whatsoever to be used by means of a suitable file system pilot. In fact, the basic functions are identical: opening a file, reading and writing in it, closing it, retrieving the content of a directory, etc. It doesn't matter how the file system manages its internal architecture. History means that classic file systems have a tree structure: there is a root 105 (generally represented by “C:”), the directories 110 to 125 are nodes of the tree-structures, and the files 130 and 135 are the terminal nodes of the tree structure.

Thanks to the utilization of the present invention, for the host system to which the device's case is connected, remote data, accessible via a communication network, wired or wireless, appear as files, organized in directories and sub-directories linked to a root representing the device in the host system's file system. The host system is, preferentially, a media renderer, i.e. it is able to process and provide, in a noticeable way, the content of the files that it reads. For example, the host system is a television, an audio system or a radio.

On a local network, the UPnP audio-video servers and the resources that they shelter are, in essence, organized in tree-structures. The root 150 (“Network:”) contains a first series of nodes 155 to 170, which are the available servers. Each of these servers exports a certain number of categories, which form a second layer of nodes, etc, through to the final resources 175 and 180, which form the terminal nodes and which represent the actual data to be used.

This network is, in embodiments, linked to the Internet. In the same way, services outputting media on the Internet are presented as directories of media proposed to the users. Thus there are services presenting radio stations, such as vTuner or Rhapsody (registered trademarks), music, such as iTunes (registered trademark), videos, such as YouTube (registered trademark), or images, such as GalleryPlayer (registered trademark). There are also services presenting personal media, and in particular Picassa and Flickr (registered trademarks) for images. These services may require prior identification of the user, a step that can be carried out in the man-machine interface of the device that is the subject of the present invention.

The present invention envisages equating a real tree-structure, corresponding to a physical file system, to a virtual tree-structure, corresponding to the network seen from the point of use.

It is noted that, in a first particular embodiment shown in FIG. 2a, the software implementing the process that is the subject of the present invention comprises, in ascending order of layers of the representation of layers standardized by ISO:
a USB transport layer 235, of a known type in the field of USB interfaces,
a USB Mass Storage Profile layer 230 of a known type in the field of USB interfaces of data storage systems, for example USB keys,
a FAT-type (acronym for “File Allocation Table”) file system layer 225, of a known type in the field of personal computers,
a virtual file system layer 220,
a UPnP protocol layer 215, of a known type in devices utilizing the UPnP protocol, and associated to the http type of data transfer protocol,
a transcoding, packetization and depacketization layer 212,
an IP/WiFi stack layer 210, of a known type in the field of communications utilizing the WiFi protocol, and
a WiFi transport layer 205, of a known type in the field of communications utilizing the WiFi protocol.

It is noted that, in a variant of the first particular embodiment shown in FIG. 2b, the software implementing the process that is the subject of the present invention comprises, in ascending order of layers of the representation of layers standardized by ISO:
a USB transport layer 235, of a known type in the field of USB interfaces,
a USB Mass Storage Profile layer 230 of a known type in the field of USB interfaces of data storage systems, for example USB keys,
a FAT-type (acronym for “File Allocation Table”) file system layer 225, of a known type in the field of personal computers,
a virtual file system layer 250,
a VTuner or Rhapsody protocol layer 245, of a known type in devices utilizing remote Internet services, and associated to one or more data transfer protocols of MMS or HTTP type, for example,
a transcoding, packetization and depacketization layer 212,
an IP/WiFi stack layer 210, of a known type in the field of communications utilizing the WiFi protocol, and
a WiFi transport layer 205, of a known type in the field of communications utilizing the WiFi protocol.

These two variants of the first particular embodiment may be combined in a device aiming to make multimedia contents from different services and servers simultaneously accessible as shown in layers 255 and 260 of FIG. 2c, which combine layers 215 and 245, for layer 255, and layers 220 and 250, for layer 260.

In the embodiment shown in FIGS. 2a and 4, the device that is the subject of the present invention emulates a FAT-type file system, by re-directing or anticipating requests for access to the UPnP servers from the network through the UPnP protocol. Thus, a “list the root entries” type of request corresponds to a UPnP servers discovery, “change directory” corresponds to a “list the content of the corresponding server”, “read a file” corresponds to “start the network transfer to download the content”, and so on, all the responses being, on input to the host system, formatted as responses from a file system.

In a particular embodiment, and in the case where the device that is the subject of the present invention detects several WiFi networks, it displays them, seen from the host system, as directories and the corresponding configurations for using these different networks are used.

FIG. 3 shows a particular embodiment of the device that is the subject of the present invention, comprising, in a case 330:
a processor 305, of a known type, adapted to the electrical power supply available on a standard USB connector,
a read-only memory 310, of a known type, which holds, at least partially, the software implementing the process that is the subject of the present invention,
a random-access memory 315, of a known type,
a USB 2.0 connector 325, of a known type, and
a WiFi 802.11 G interface 320, of a known type.

This device enables communication between at least one multimedia content medium accessible by means of a network, by means of the interface 320 and a host system able to process a said content, by means of the connector 325. With the software held in memories 310 and/or 315, the processor 305 is a means of managing the connector 325 by utilizing a protocol authorizing connections and disconnections of data carriers to the host system, and allowing the host system to read files present in the case 330.

In a variant, the connector 325 is an SD/MMC (acronym for “Secure Digital/MultiMedia Card”), IEEE1394 or Wireless USB (acronym for “Wireless Universal Serial Bus”) type.

The interface management protocol used for communication with the wireless interface 320 is, according to embodiments, the UPnP standard (acronym for “Universal Plug and Play”, a standard for communication over the local network), the MMS standard (acronym for “Microsoft Media Services”, a standard for multimedia file communication over to the network), the RTSP standard (acronym for “Real Time Streaming Protocol”, a standard for multimedia file communication over the network).

With the software held in memories 310 and/or 315 and the interface 320, the processor 305 constitutes a means of communication with said network by utilizing an interface management protocol. With the software held in memories 310 and/or 315, the processor 305 constitutes, in addition, a means of simulation adapted, in order to represent said contents accessible to the host system by means of the communications means and the network, to simulate, on the host system, a tree-structure of files present in said case, as described with respect to FIG. 1. With the software held in memories 310 and/or 315, the processor 305 also constitutes a means of access to at least one said content accessible by means of the network through the use, by the host system, of its representation in the tree-structure of files present in the simulated case.

By utilizing the present invention:
the device is presented as a USB client, firstly, is able manage a WiFi type of network interface, secondly, and presents a local processing capability (relatively limited, for example of ARM7 type—100 MHz),
a virtual file system is realized replicating all the FAT32 APIs on the corresponding UPnP calls, and the necessary format transcriptions are carried out (return structures, validity of character strings, etc),
a system is realized configuring the device on the host system, for example a personal computer, via the USB interface for, among others, setting the network parameters and
the conditions are resolved to the limits and problems described below, at least.

1/ With respect to the dynamic aspect, a USB key inserted in a host system which only reads it has no reason to see its content change. Thus, in most cases, the host system's software takes a partial or total “photo” of the key's content when it is inserted and does not go back to it. However, in the context of the present invention, the network accessible by means of the device is dynamic since servers can be added to or removed from the network and the contents available on these servers can change according to actions on the servers. There is therefore the risk of only having available the status of the network at the time of the connection of the device and the host system and its listing by the USB protocol.

Preferentially, the device's driver, which operates on the host system, utilizes a man-machine interface or a specific selection protocol, local or remote. The man-machine interface allows the user to select remote files to be represented in this interface and to define filters selecting files to be represented in the interface. For example, a filter only will only let pass one type of file, for example audio, video or fixed image, or only one type of file name extension, for example “.jpg”, “.mp3” or “.wmv”.

With respect to the means of selecting files to be output, the user may, in embodiments, utilize a screen incorporated in the device's case, at least one selection key and at least one means of navigating the tree-structure. In particular embodiments, the user will utilize a case that is autonomous in terms of power, and the means of selection and navigation described above. In other embodiments, the user utilizes the host system or another terminal linked to the network and means of selection and navigation known to people in this field, for example in the form of the man-machine interface described above.

In an embodiment of the present invention, the device simulates the disconnection/re-connection of the host system during operation when a UPnP event occurs, so that the host system takes another photo of the contents accessible by means of the device. Preferentially, if data accessible remotely are being received, the device inhibits the steps simulating disconnection and re-connection.

Preferentially, the tree-structure of the accessible data is only retrieved on request from the host system. Thus, a server's directories and sub-directories are only detailed on access to this server's main directory. The number of disconnection/re-connection simulations to be performed is thus reduced. In embodiments, the disconnection/re-connection simulation can be performed on request received via the means of communication.

2/ In the case where the host system to which the device that is the subject of the present invention is linked switches to “standby mode”, the amperage available for the device is reduced to less than one mA. Preferentially, the present invention utilizes a request message from the host system, which waits until the device has given agreement before putting itself on standby. In a variant, the message sent by the host system represents a time given to the peripherals to switch off “properly” before the standby and possibly allowing them to signal their change of status. With regard to the device that is the subject of the present invention, this phase can take the form of a “bye” command, according to UPnP protocol terminology, or a request specified by the MMS or RTSP protocol.

3/ The device that is the subject of the present invention can be implemented in the form of an accessory key for an external USB port when it comprises a suitable connector, which is preferential. However, a good many host systems that do not have ports on the surface have a USB bus available and the utilization of this device allows them to be made UPnP compatible simply and at low cost, subject to them being linked to the internal USB bus. Generally these systems are limited with respect to decoding formats: on a DVD reader, for example, you may only have MPEG-2 video format. Moreover, it is impossible to “configure” the device on a personal computer, or PC, type of host system and the host system must therefore, in this case, at least re-integrate the interface or the configuration system on its main processor in order to configure the device that is the subject of the present invention. In this way, the invention extends to USB bus uses internal to the host system.

In embodiments of the present invention, an installation compact disk, or CD, is provided, which carries out the parameterization and/or the configuration of communications between the host system and the device. Otherwise, specific software is provided in the device's central processor. In this case. Preferentially, the device presents a small display screen and several keys, like an “MP3 player” type of media player. In a variant, the device behaves like an MP3 player when it is not linked to the host system. Preferentially, the device's configuration utilizes encryption methods to ensure the confidentiality of data communications to the device that is the subject of the present invention.

In a general way, configuration by the user concerns the tree-structure simulation, each transcoding, the identification of the user and/or the communication with the network.

In particular embodiments, such as that shown in FIG. 4, the format decoding limitations of the host system in question are taken into account. Preferentially, transcoding is “on the fly” from any format whatsoever to a format defined by the user according to the host system's capabilities. Thus the device that is the subject of the present invention can take any format whatsoever out of the network and, in real-time, transform it into an intermediary format, or “pivot”, requiring the addition of a transcoding layer between the UPnP (which is only responsible for transport and availability) and the virtual file system by which the host system receives the data.

It is noted that, in a second particular embodiment shown in FIG. 4, the software implementing the process that is the subject of the present invention comprises, in ascending order of layers of the representation of layers standardized by ISO:
a USB transport layer 440, of a known type in the field of USB interfaces,
a USB Mass Storage Profile layer 435 of a known type in the field of USB interfaces of data storage systems, for example USB keys,
a FAT32-type (acronym for “File Allocation Table”) file system layer 430, of a known type in the field of personal computers,
a virtual file system layer 425,
a transcoder layer and UPnP wrapper layer 420, which, receiving data in a first format, for example MPEG4, reformulates them, in real time, into a format that can be read by the host system, which uses the device that is the subject of the present invention, for example in MPEG2 format (in practice, these algorithms can be utilized by software systems and a general-purpose processor or benefit from hardware accelerators. VLC software, registered trademark, on PCs, for example, fulfills this task),
a UPnP stack layer 415, of a known type in devices utilizing the UPnP protocol,
an TCP/IP stack layer 410, of a known type in the field of communications utilizing the TCP/IP protocol, and
a WiFi transport layer 405, of a known type in the field of communications utilizing the WiFi protocol.

FIG. 5 shows that when the device that is the subject of the present invention is powered by a host system, it performs its initialization, step 505. During this initialization, a protocol authorizing connections and disconnections of data carriers to the host system is utilized, said host system being able to read files present in said case.

Then, during a step 510, it performs a WiFi connection with other systems or servers, for example servers hosting Internet services, for example radio or photo gallery, and a UPnP request to determine which of these other systems support the UPnP protocol. From step 510, in order to communicate with said network, an interface management protocol described below is utilized.

It is noted that, in order to maintain, on these servers, relationships with proprietary media or media selected by the user, preferentially the device has a unique identifier that is communicated remotely during the connection. It is noted that the WiFi connection can utilize the WPS standard (acronym for WiFi Protected Setup), the connection being effected by using specific buttons during a predefined time interval.

During a step 515, according to the responses received from other systems, the device constitutes, with some of them, a wireless local network utilizing both UPnP and WiFi protocols.

Then, during a step 520, the device sends each of the UPnP servers a description request for the directories it utilizes that comprise media available for output.

During a step 525, the device constitutes a first tree-structure of the directories of which it has received a description, even partial.

During a step 530, a USB disconnection and re-connection is carried out in order that the host system has knowledge of at least the first level of the directory tree-structure, i.e. generally the directories assigned, individually, each to at least one of the entries of the UPnP servers or to MMS or RTSP services with which the device is in communication.

During a step 535, the device determines whether a UPnP event has been detected. Such an event is, generally, the removal of a server from the network or the arrival of a new server in this network.

If yes, step 525 is performed again. If no, during a step 540, it is determined whether one of the servers was interrogated by the host system. If no, step 535 is performed again. If yes, during a step 545, a UPnP request is output over the wireless local network in order to obtain from the server in question an additional layer of the tree-structure and this additional tree-structure level is made available to the host system, during a step 550. Steps 545 and 550 are repeated until the host system no longer interrogates the device, in which case, after a pre-defined length of time, for example ten seconds, during a step 555 it is determined whether the host device has requested to read a medium. In order to access at least one said content accessible by means of the network, its representation in said tree-structure is used. According to embodiments, this tree-structure is used with a screen integrated to the device that is the subject of the present invention (see FIGS. 6 and 7) or the host system's display and selection capabilities.

If the result of the step 555 is negative, step 535 is performed again. If the result of the step 555 is positive, during a step 560, by means of the wireless local network and the device that is the subject of the present invention, the server that was interrogated supplies the medium requested to the host system.

Then, during a step 565, it is determined whether the reading of the medium has been interrupted or has finished. If no, step 560 is performed again. If yes, step 535 is performed again.

Below is described a particular embodiment of the device that is the subject of the present invention, which envisages providing an access to contents on a network to host systems that have a USB connector and can handle mass storage devices, by presenting the remote contents as local files. Here access to the network is by means of a WiFi interface complying with standard 802.11b/g.

For the user, utilizing this device consists of carrying out a step configuring the hardware access, i.e. the WiFi connection itself and access to the content available on the network. Then, once connected to the host system, the device gives access to the contents on the network according to the user's configuration data.

Physically, as shown in FIG. 6, the device is presented as a case 605, for example of dimensions 85 mm (L)×25 mm (W)×15 mm (H), equipped with a USB connector 610, a screen 615, buttons 620 and a rotary knob 625. This case 605 comprises a printed circuit, the main components of which are shown in FIG. 7. These components comprise in particular a microprocessor 630, random-access memory 635, read-only memory 640 and the screen 615.

With the software held in memories 635 and/or 640 and the WiFi interface, the processor 630 constitutes a means of communication with said network utilizing an interface management protocol. With the software held in memories 635 and/or 640, the processor 630 constitutes, in addition, a means of simulation adapted, in order to represent said contents accessible to the host system by means of the communications means and the network, to simulate, on the host system, a tree-structure of files present in said case, as described with respect to FIG. 1. With the software held in memories 635 and/or 640, the processor 630 also constitutes a means of access to at least one said content accessible by means of the network through the use, by the host system, of its representation in the tree-structure of files present in the simulated case.

With respect to compatibility, on the network side, the device is able to connect to any WiFi network meeting standard 802.11b/g, with supported encryption standards, for example WEP64, WEP128 and WPA. The network protocols comprise TCP/IP IPv4. The protocol used to communicate with the media servers responds to specification DLNA 1.2 with respect to discovery and streaming.

On the USB connector side, the device acts as a mass storage device formatted in FAT-32. USB 2.0 full-speed mode of 12 Mbps, USB 1.1-compatable, is preferentially used to provide extended interoperability.

The device can be associated to software for PCs, or pilots.

Because of the different positions of the USB connectors on the host systems, preferentially the device comprises an orientation sensor that detects the device's horizontal and vertical axes. For the same reason, the screen is preferentially square, so that the management of the user interface according to the detected orientation of the device becomes a simple rotation.

With regard to the electrical power supply, all or part comes from the host system via the USB connector and, in a variant, a battery allows the device to operate in autonomous MP3 player or configuration mode.

With regard to modes of operation, the device supports the following modes:
“Of”: in this mode, the device is completely switched off and only switches on when it is connected to the host system;
“StandBy”: this mode is utilized when the host system is itself on standby or when it rejects the negotiation of electrical power and
“Full Power”: in this mode, all the peripherals operate as rated.

Preferentially, the device is fully compatible with Windows Media Player 11 (registered trademarks) which acts as a UPnP server on PC (acronym for personal computer) types of remote systems.

With respect to the user interface, buttons and a rotary selector are provided, This interface allows the user to indicate to which part of the contents he/she wants to access, either by manual selecting branches of the content tree-structure or during the initial configuration, possibly updated. A “favorites” directory is also provided for.

With respect to access to media in “pull” mode, the device gives access to the network and UPnP contents. With respect to access to media in “push” mode, it is noted that the device that is the subject of the present invention is visible on the external network as a UPnP media renderer, thanks to a dedicated application operating on this device. All types of external devices comprising a UPnP controller will be capable of pushing content or a list of contents present on the network to this “UPnP media renderer”. Once pushed, the content or list of contents will be made available to the user by simulating a disconnection/re-connection. This content or list will appear in the tree-structure at the root and, for certain host systems, reading will be done automatically. The device that is the subject of the present invention is thus adapted to receive unrequested contents, i.e. not having been the subject of a specific request on its behalf coming from the network.

Even though the present invention has been described in a preferential embodiment in which it utilizes a USB connector, a UPnP/WiFi network, the present invention is not restricted to these types of connector, protocol and network but, on the contrary, extends to any type of connector for removable memory, for example complying with MMC (acronym for MultiMediaCard), SD (acronym for Secure Digital), Memory Stick (registered trademark of Sony), SM (acronym for SmartMedia) standards, and all types of protocols and networks, for example Ethernet (registered trademark).

1-22. (canceled)

23. A device for communications between at least one multimedia content medium accessible by means of a network and a host system able to process a said content, that comprises, in a case:
a connector adapted to be connected to the host system;
a means of managing the connector utilizing a protocol authorizing connections and disconnections of data carriers to the host system, said host system being able to read files present in said case;
a means of communication with said network utilizing an interface management protocol;
a means of simulation adapted, in order to represent said contents accessible to the host system by means of the communications means and the network, to simulate, on the host system, a tree-structure of files present in said case and
a means of access to at least one said content accessible by means of the network through use of its representation in said tree-structure.

24. A device according to claim 23, wherein the means of simulation is adapted in that the root of the simulated tree-structure is the network.

25. A device according to claim 23, wherein the host system is a media renderer.

26. A device according to claim 23, wherein said network is connected to the Internet.

27. A device according to claim 23, that further comprises a means of receiving unrequested content coming from said network.

28. A device according to claim 23, wherein said connector is a USB type (acronym for “Universal Serial Bus”).

29. A device according to claim 23, wherein said connector is an SD/MMC type (acronym for “Secure Digital/MultiMedia Card”).

30. A device according to claim 23, wherein said connector is an IEEE1394 type.

31. A device according to claim 23, wherein said connector is a wireless connector, of Wireless USB type (acronym for “Wireless Universal Serial Bus”).

32. A device according to claim 23, wherein the means of communication is a means of communication utilizing the UPnP standard (acronym for “Universal Plug and Play”).

33. A device according to claim 23, wherein the interface management protocol used utilizes the UPnP standard (acronym for “Universal Plug and Play”, a standard for communication over the local network).

34. A device according to claim 23, wherein the interface management protocol used utilizes the MMS standard (acronym for “Microsoft Media Services”, a standard for multimedia file communication over the network).

35. A device according to claim 23, wherein the interface management protocol used utilizes the RTSP standard (acronym for “Real Time Streaming Protocol”, a standard for multimedia file communication over the network).

36. A device according to claim 23, wherein the means of communication is a wireless means of communication utilizing the WiFi standard (acronym for “Wireless Fidelity”).

37. A device according to claim 23, wherein the means of simulating the tree-structure is adapted to represent, by a directory, the contents accessible by means of the network over the same remote device.

38. A device according to claim 23, that further comprises a means of emulating a file system of FAT type (acronym for “File Allocation Table”) by re-directing requests to access files coming from the host system to the network servers, via said protocol.

39. A device according to claim 23, that further comprises a means of simulating, for the host system, the disconnection and re-connection of the device, on the one hand, and of the host system, on the other hand, during a pre-defined event assigning a remote connection with an available data server.

40. A device according to claim 23, that comprises a means of inhibiting the means of simulating the disconnection and re-connection during a transfer of available remote data to the host system.

41. A device according to claim 23, wherein the means of simulating the local file tree-structure adapted to represent remote data is adapted to only determine a directory's sub-directories during an access to the directory by the host system.

42. A device according to claim 23, that further comprises a means of transcoding data available remotely received from the host system.

43. A device according to claim 23, that further comprises a means of configuring by the user the simulation of the tree-structure, a transcoding, an identification of the user and/or the communication with said network.

44. A process of communication between at least one multimedia content medium accessible by means of a network and a host system able to process a said content, that comprises:
a step of managing a connector of a case adapted to be connected to the host system, utilizing a protocol authorizing connections and disconnections of data carriers to the host system, said host system being able to read files present in said case;
a step of communicating with said network utilizing an interface management protocol;
a simulation step, in order to represent said contents accessible to the host system by means of the communications means and the network, by simulating, on the host system, a tree-structure of files present in said case and
a step of accessing at least one said content accessible by means of the network through use of its representation in said tree-structure.
